(19) United States
(12) Patent Application Publication
(10) Pub. No.: US 2026/0101409 A1
(43) Pub. Date: Apr. 9, 2026

(54) ENERGY STATUS REPORTING FOR INTERNET-OF-THINGS (IOT) DEVICES

(71) Applicant: Lenovo (United States) Inc., Morrisville, NC (US)

(72) Inventors: Hyung-Nam Choi, Ottobrunn (DE); Karthikeyan Ganesan, Kronberg Im Taunus (DE); Ali Ramadan Ali, Kraiburg (DE)

(73) Assignee: Lenovo (United States) Inc., Morrisville, NC (US)

(21) Appl. No.: 18/905,896

(22) Filed: Oct. 3, 2024

(51) Int. Cl. H04W 76/27

(52) U.S. Cl. CPC H04W 76/27

(57) ABSTRACT

Various aspects of the present disclosure relate to energy status reporting for Internet-of-Things (IoT) and ambient IoT (AIoT) devices. An apparatus, such as a wireless communication device, may transmit a first message to an IoT device. The wireless communication device may be a reader such as a user equipment (UE) or a network equipment (NE). The first message may include a set of one or more parameters associated with an energy status of the IoT device. The IoT device may determine its actual energy status based on the parameters. The wireless communication device may receive, from the IoT device, a second message (e.g., an energy status report) that includes information associated with the energy status of the IoT device.

### TECHNICAL FIELD

The present disclosure relates to wireless communications, and more specifically to managing operation of ambient Internet-of-Things (AIoT) devices based on energy status in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a wireless communication device (e.g., a UE or an NE) for wireless communication to transmit, to an IoT device, a first message that includes a set of one or more parameters associated with an energy status of the IoT device; and receive, from the IoT device, a second message that includes information associated with the energy status of the IoT device based at least in part on the set of one or more parameters.

In some implementations of the method and apparatuses described herein, the wireless communication device initiates communication with the IoT device based at least in part on the transmitted first message. Additionally, or alternatively, the information indicates one or more of whether stored energy at the IoT device is sufficient to perform communication, a span associated with the stored energy, or a charging duration to obtain a capacitance level for performing the communication.

In some implementations of the method and apparatuses described herein, the wireless communication device transmits, to the IoT device, a third message that schedules an occasion for communication with the IoT device based at least in part on the information. In some implementations of the method and apparatuses described herein, the wireless communication device transmits, based at least in part on the energy status, a third message that triggers the IoT device to switch from a first state to a second state, wherein the first state comprises an active state, and wherein the second state comprises a deactive state. In some implementations of the method and apparatuses described herein, the wireless communication device selects one or more IoT devices for communication based at least in part on the energy status being sufficient for the communication.

In some implementations of the method and apparatuses described herein, the wireless communication device initiates a timer that suspends communications between the wireless communication device and the IoT device based at least in part on the information; and transmits, to the IoT device, a third message that resumes the communications between the wireless communication device and the IoT device based at least in part on expiration of the timer. In some implementations of the method and apparatuses described herein, wherein the wireless communication device comprises a UE or an NE.

Some implementations of the method and apparatuses described herein may further include a processor for wireless communication to transmit, to an IoT device, a first message that includes a set of one or more parameters associated with an energy status of the IoT device; and receive, from the IoT device, a second message that includes information associated with the energy status of the IoT device based at least in part on the set of one or more parameters.

Some implementations of the method and apparatuses described herein may further include a method performed by a wireless communication device, the method including transmitting, to an IoT device, a first message that includes a set of one or more parameters associated with an energy status of the IoT device; and receiving, from the IoT device, a second message that includes information associated with the energy status of the IoT device based at least in part on the set of one or more parameters.

In some implementations of the method and apparatuses described herein, the wireless communication device initiates communication with the IoT device based at least in part on the transmitted first message. Additionally, or alternatively, the information indicates one or more of whether stored energy at the IoT device is sufficient to perform communication, a span associated with the stored energy, or a charging duration to obtain a capacitance level for performing the communication.

In some implementations of the method and apparatuses described herein, the method further comprises transmitting, to the IoT device, a third message that schedules an occasion for communication with the IoT device based at least in part on the information. In some implementations of the method and apparatuses described herein, the method further comprises transmitting, based at least in part on the energy status, a third message that triggers the IoT device to switch from a first state to a second state, wherein the first state comprises an active state, and wherein the second state comprises a deactive state.

In some implementations of the method and apparatuses described herein, the method further comprises initiating a timer that suspends communications between the wireless communication device and the IoT device based at least in part on the information; and transmitting, to the IoT device, a third message that resumes the communications between the wireless communication device and the IoT device based at least in part on expiration of the timer. In some implementations of the method and apparatuses described herein, wherein the wireless communication device comprises a UE or an NE.

Some implementations of the method and apparatuses described herein may further include an IoT device for wireless communication to receive, from a wireless communication device, a first message that includes a set of one or more parametersone or more parameters associated with an energy status of the IoT device; determine the energy status based at least in part on the set of one or more parameters; and transmit, to the wireless communication device, a second message that includes information associated with the energy status of the IoT device.

In some implementations of the method and apparatuses described herein, the set of one or more parameters comprises one or more of a reference duration, a reference power consumption of the IoT device, or a type of the information. Additionally, or alternatively, the information indicates one or more of whether stored energy at the IoT device is sufficient to perform communication, a span associated with the stored energy, or a charging duration to obtain a capacitance level for performing the communication.

In some implementations of the method and apparatuses described herein, the IoT device receives, from the wireless communication device, a third message that schedules an occasion for communication with the IoT device based at least in part on the information. In some implementations of the method and apparatuses described herein, the IoT device selects a time occasion for communicating with the wireless communication device based at least in part on the information.

Some implementations of the method and apparatuses described herein may further include a processor for wireless communication to receive, from a wireless communication device, a first message that includes a set of one or more parameters associated with an energy status of the IoT device; determine the energy status based at least in part on the set of one or more parameters; and transmit, to the wireless communication device, a second message that includes information associated with the energy status of the IoT device.

Some implementations of the method and apparatuses described herein may further include a method performed by an IoT device, the method including receiving, from a wireless communication device, a first message that includes a set of one or more parameters associated with an energy status of the IoT device; determining the energy status based at least in part on the set of one or more parameters; and transmitting, to the wireless communication device, a second message that includes information associated with the energy status of the IoT device.

In some implementations of the method and apparatuses described herein, the set of one or more parameters comprises one or more of a reference duration, a reference power consumption of the IoT device, or a type of the information. Additionally, or alternatively, the information indicates one or more of whether stored energy at the IoT device is sufficient to perform communication, a span associated with the stored energy, or a charging duration to obtain a capacitance level for performing the communication.

In some implementations of the method and apparatuses described herein, the method further comprises receiving, from the wireless communication device, a third message that schedules an occasion for communication with the IoT device based at least in part on the information. In some implementations of the method and apparatuses described herein, the method further comprises selecting a time occasion for communicating with the wireless communication device based at least in part on the information.

### BRIEF DESCRIPTION OF THE DRAWINGS

FIG. 1 illustrates an example of a wireless communications system in accordance with aspects of the present disclosure.

FIG. 2 illustrates an example AIoT device operation, in accordance with aspects of the present disclosure.

FIG. 3 illustrates example deployment scenarios, in accordance with aspects of the present disclosure.

FIGS. 4a and 4b illustrate examples of protocol stacks, in accordance with aspects of the present disclosure.

FIGS. 5 through 11 illustrate examples of signaling diagrams, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates an example of an IoT device in accordance with aspects of the present disclosure.

FIG. 16 illustrates a flowchart of a method performed by a wireless communication device in accordance with aspects of the present disclosure.

FIG. 17 illustrates a flowchart of a method performed by an IoT device in accordance with aspects of the present disclosure.

### DETAILED DESCRIPTION

In a wireless communications system, a UE and an NE (e.g., a base station, gNB) may support wireless communication (e.g., reception and/or transmission of wireless communication) with an AIoT device. An AIoT device may be an ultra-low-complexity device with ultra-lower power consumption for very low-end IoT applications, such as inventory-taking, sensor data collection, tracking, and actuator control, among others. Energy may be provided to an AIoT device through energy harvesting, which may include the harvesting of radio waves, light, motion, heat, or any other suitable energy source.

AIoT devices may be used for indoor inventory and indoor command use cases. Indoor inventory may refer to the process of taking inventory of one or multiple AIoT devices that are located indoors, and indoor command may refer to commands to read, write, control, enable, or disable one or multiple AIoT devices that are located indoors. An indoor location may include a warehouse, a factory, a mall, an airport terminal, and a home, among other locations.

Depending on a number of targeted AIoT devices, inventory and command procedures may take some time. As a result, an AIoT device may sustain its operation (e.g., for transmission, reception, and data processing) during an inventory procedure or a command procedure without harvesting energy for some period of time, and the AIoT device may harvest energy during a time period corresponding to an outage. To store the harvested energy, an AIoT device may be equipped with a capacitor, however a capacitance size and a required energy charging time may vary depending on implementation (e.g., may take up to several tens of seconds). As such, to successfully perform an inventory or command procedure for AIoT devices, a wireless communication device (e.g., a reader, such as a UE or an NE) may take an actual energy status of the AIoT devices during the procedure.

Aspects of the present disclosure are described in the context of a wireless communications system, and include implementations that provide for the reporting of actual energy status information by AIoT devices, and for operating AIoT devices based on the actual energy status information. A UE or an NE (e.g., a wireless communication device, a reader) may transmit a first message to an AIoT device, the first message including a set of one or more parameters associated with an energy status of the AIoT device. The AIoT device may determine the energy status and transmit a second message to the UE or the NE that includes information associated with the energy status. The UE or the NE may use the energy status to increase a radio frequency (RF) power of subsequent transmissions for reader-to-device (R2D) messages or carrier wave signals, select one or more targeted AIoT devices for a subsequent procedure, adapt a procedure for the targeted AIoT devices, or transfer the targeted AIoT devices to a definite device state based on their actual energy status.

By performing the described techniques, wireless communications systems may become more efficient as the operation of AIoT devices during an inventory and/or command procedure may be performed based on their actual energy status. Additionally, the described techniques may improve consistency and effectiveness of inventory and command procedures as the procedures may consider the actual energy status of an AIoT device (regardless of implementation). Moreover, reporting the actual energy status of an AIoT device may improve signaling reliability and throughput and decrease signaling latency as a UE or an NE may use the energy status to improve or otherwise adapt inventory and command procedures and other wireless communications. Additionally, different implementations of AIoT devices with regards to energy storage and power consumption may be supported for AIoT operation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

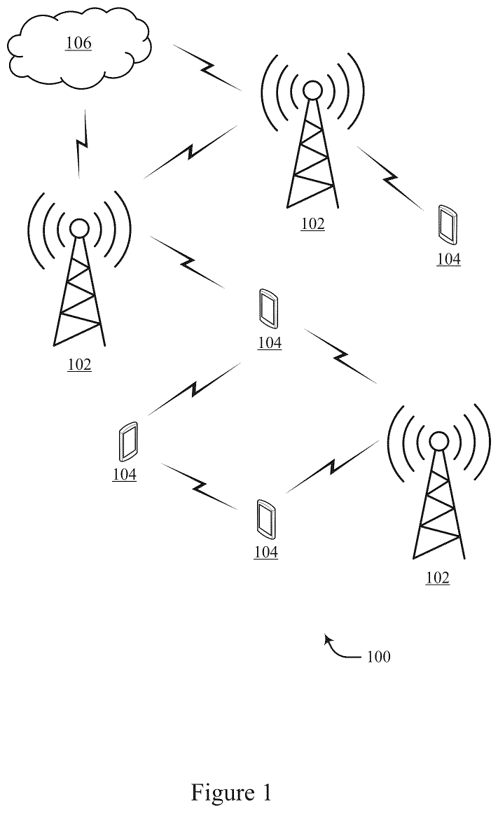

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interfaces). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core, or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NEs 102 associated with the CN 106.

The CN 106 may communicate with a packet data network over one or more backhaul links (e.g., via an S1, N2, N6, or other network interfaces). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHz-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 or an NE 102 (e.g., a wireless communication device, a reader) may transmit a first message to an AIoT device, the first message including a set of one or more parameters associated with an energy status of the AIoT device. The AIoT device may determine the energy status and transmit a second message to the UE or the NE that includes information associated with the energy status. The UE 104 or the NE 102 may use the energy status to increase an RF power of subsequent transmissions for R2D messages or carrier wave signals, select one or more targeted AIoT devices for a subsequent procedure, adapt a procedure for the targeted AIoT devices, or transfer the targeted AIoT devices to a definite device state based on their actual energy status.

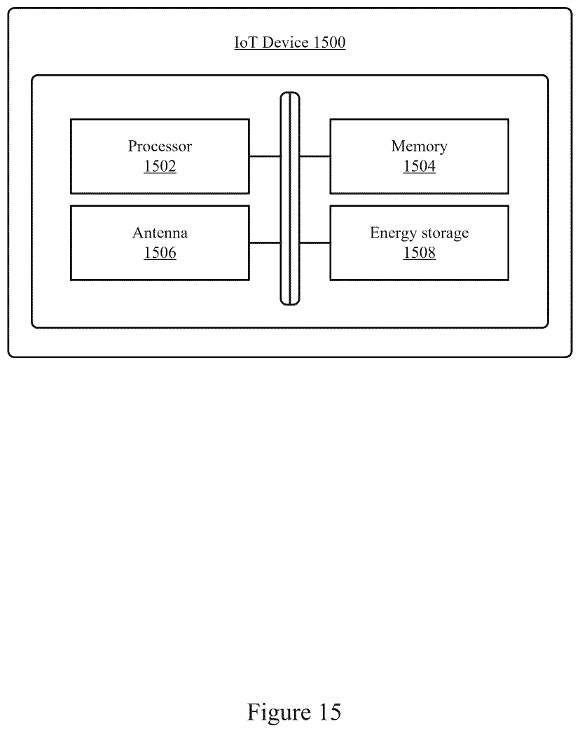

The primary components of an AIoT device architecture include an antenna, a processor, a memory, and energy storage. FIG. 15 depicts an AIoT device architecture. An AIoT device may use an antenna to transmit or receive RF signals to or from a UE 104 or an NE 102 (e.g., a reader). Passive AIoT devices may use the antenna to receive an unmodulated carrier wave from the reader, an external carrier wave node, or both. The AIoT device may use the carrier wave to transmit RF signals to the UE 104 or the NE 102 based on backscattering. In addition, the AIoT device may use the antenna to harvest energy from the radio waves received from the UE 104, the NE 102, or the external carrier wave node.

The AIoT device may use the processor to perform all processing for communication between the AIoT device and the UE 104 or the NE 102, including modulation, demodulation, encoding, and decoding of information that the AIoT transmits and receives, and reading and writing information to and from memory. The AIoT may use the memory to store information used for operation of the AIoT device. The memory size may vary (e.g., from 1 kByte to 8 kBytes), and may depend on applications the AIoT device supports. Additionally, the memory may include non-volatile memory (NVM) or volatile memory (VM). The AIoT device may use NVM for permanently storing information (e.g., any information stored in NVM may not get lost even if there is no energy available in the AIoT device). The AIoT device may use the VM for temporarily storing information that is used for its operation only while energy is available in the AIoT device.

The energy storage may store and supply energy for the AIoT device. AIoT devices of types 1, 2a, and 2b may harvest energy from radio waves received from the UE 104, the NE 102, an external carrier wave node, or any other suitable energy source (e.g., light, motion, heat). The type 1, 2a, or 2b AIoT devices may store the harvested energy in a capacitor, where a capacitance size and a required energy charging time may vary depending on implementation (e.g., may take up to several tens of seconds). Factors affecting energy charging time may include capacitance size and resistance values. Table 1 depicts energy charging times considering different capacitance sizes and resistance values.

TABLE 1

| R (kΩ) | 1 μF | 2 μF | 3 μF | 4 μF | 5 μF | 6 μF | 7 μF | 8 μF | 9 μF | 10 μF |
|---|---|---|---|---|---|---|---|---|---|---|
| 1 | 5 | 10 | 15 | 20 | 25 | 30 | 35 | 40 | 45 | 50 |
| 20 | 100 | 200 | 300 | 400 | 500 | 600 | 700 | 800 | 900 | 1000 |
| 100 | 500 | 1000 | 1500 | 2000 | 2500 | 3000 | 3500 | 4000 | 4500 | 5000 |
| 1000 | 5000 | 10000 | 15000 | 20000 | 25000 | 30000 | 35000 | 40000 | 45000 | 50000 |

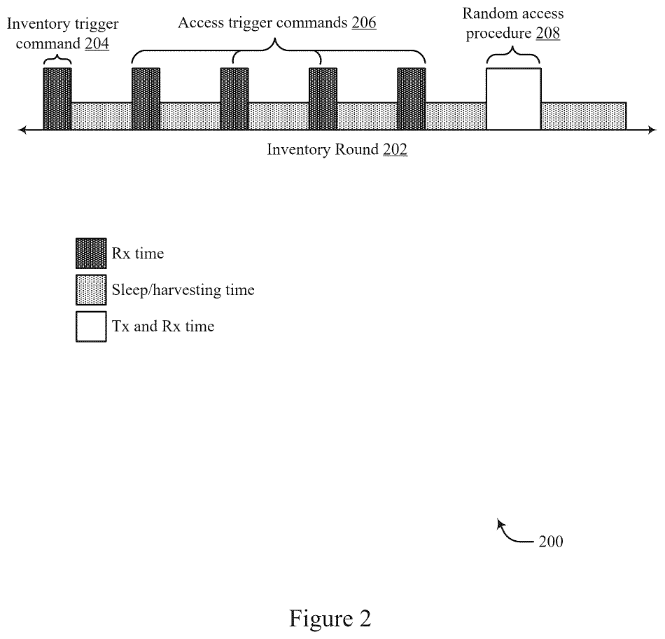

FIG. 2 illustrates an example AIoT device operation 200 in accordance with aspects of the present disclosure. The AIoT device operation 200 may depict the operation (e.g., behavior) of an AIoT device during an inventory round 202. The inventory round 202 may include different time periods including receive time (Rx time) (e.g., during which the AIoT device may receive messages), transmit and receive time (Tx and Rx time) (e.g., during which the AIoT device may transmit and receive messages), and sleep/harvesting time (e.g., during which the AIoT device may operate in a sleep mode or may harvest energy).

As described herein, depending on a number of targeted AIoT devices, inventory and command procedures may take some time. As a result, an AIoT device may sustain its operation (e.g., for transmission, reception, and data processing) during an inventory procedure or a command procedure without harvesting energy for some period of time, and the AIoT device may harvest energy during a time period corresponding to an outage (e.g., a sleep/harvesting time). For example, during the inventory round 202, the AIoT device may receive an inventory trigger command 204. The inventory trigger command 204 may trigger an inventory procedure for one or more AIoT devices. After a sleep/harvesting time period, the AIoT device may receive a series of access trigger commands 206, each separated by a sleep/harvesting time period (e.g., during which the AIoT device may harvest energy). An access trigger command 206 may trigger access of an AIoT device to a UE or an NE (e.g., a reader) via a random access procedure (e.g., via a 3-step contention-based random access (CBRA) procedure) for transmitting an AIoT device identifier (ID) (e.g., an electronic product code (EPC)). After receiving a fourth access trigger command 206, the AIoT device may perform a random access procedure 208.

Table 2 illustrates design targets for AIoT devices (e.g., for study in 3GPP Release 19).

TABLE 2

| Design | Target | Note |
|---|---|---|
| Device types | Type 1: ~1 μW peak power | Transmission from Ambient IoT |
| | consumption, has energy storage, | device (including backscattering |
| | initial sampling frequency offset | when used) can occur at least in |
| | (SFO) up to 10^{X} ppm, neither DL | UL spectrum. |
| | nor UL amplification in the device. | Type 1 and Type 2a devices are |
| | The device's UL transmission is | passive devices, whereas Type 2b |
| | backscattered on a carrier wave | devices are active devices. |
| | provided externally. | |
| | Type 2a: ≤a few hundred μW peak | |
| | power consumption, has energy | |
| | storage, initial sampling frequency | |
| | offset (SFO) up to 10^{X} ppm, DL | |
| | and/or UL amplification in the | |
| | device. The device's UL | |
| | transmission is backscattered on a | |
| | carrier wave provided externally. | |
| | Type 2b: ≤a few hundred μW peak | |
| | power consumption, has energy | |
| | storage, initial sampling frequency | |
| | offset (SFO) up to 10^{X} ppm, DL | |
| | and/or UL amplification in the | |
| | device. The device's UL | |
| | transmission is generated internally | |
| | by the device. | |
| Coverage/ | Max distance of 10-50 m with device | |
| communication | indoors | |
| range | | |
| Deployment | Deployment scenario 1 with | Deployment scenario 1: |
| scenarios | Topology 1 | Basestation (micro-cell, co- |
| | Deployment scenario 2 with | site) and Ambient IoT device |
| | Topology 2 and UE as intermediate | are indoor. |
| | node, under network control | Deployment scenario 2: |
| | | Basestation (macro-cell, co- |
| | | site) is outdoor and |
| | | intermediate UE/Ambient IoT |
| | | device are indoor. |
| Spectrum | FR1 licensed spectrum in FDD | FR1 refers to the frequency range |
| | | of 410 MHz-7125 MHz. |
| Spectrum | In-band to NR | |
| deployment | In guard-band to LTE/NR | |
| | In standalone band(s) | |
| Traffic types | DO-DTT (Device-originated - | Focus is on rUC1 (indoor |
| | device-terminated triggered) | inventory) and rUC4 (indoor |
| | DT (Device-terminated) | command). |
| Protocol aspects | No RRC states | |
| and mobility | No mobility (i.e. at least no cell | |
| | selection/re-selection-like function) | |
| | No HARQ | |
| | No ARQ | |

The techniques described herein support reporting actual energy status by AIoT devices and operating AIoT devices based on their energy status. The described techniques may include energy status report triggering and usage. In some examples, a reader (e.g., an NE 102, a UE 104) may trigger AIoT devices to determine and report their actual energy status. The reader may transmit an energy status report configuration in an R2D message that may include an inventory trigger command, a read/write trigger command, or any other type of command. In accordance with the energy status report configuration received from the reader, an AIoT device may determine its actual energy status and report the information back to the reader.

In some examples, the AIoT device may transmit the energy status report using a device-to-reader (D2R) message that includes a Msg1, a Msg3, or both in the case of a 3-step CBRA procedure during an inventory procedure, or the D2R message may include a new energy status report message. The reader may use the energy status report for different procedures or communications, such as increasing an RF power of subsequent transmissions for R2D messages or carrier wave signals, selecting targeted AIoT devices for a subsequent procedure, adapting a procedure for the targeted AIoT devices, or moving the targeted AIoT devices to a definite device state based on their actual energy status. In addition, the AIoT devices may use the determined energy status for selecting an appropriate inventory round during an inventory procedure.

In some implementations, support of energy status reporting may be mandatory for AIoT devices. Alternatively, the support of energy status reporting by AIoT devices may be defined as a device capability. In such cases, the operation of AIoT devices based on their energy status may be performed only after an initial inventory procedure of AIoT devices (e.g., after a successful initial inventory procedure, when the reader knows whether the AIoT devices support energy status reporting or not). The reader may know this implicitly based on a device ID (e.g., an EPC) received in a Msg3 (in the case of a 3-step CBRA procedure) or explicitly based on an energy status reporting support indication received in a Msg3 (in the case of a 3-step CBRA procedure).

Additionally, the described techniques may support an energy status report configuration and energy status report configuration reporting. An energy status report configuration may include one or more parameters associated with the actual energy status of an AIoT device, including a reference duration of the triggered procedure (e.g., in seconds), a reference power consumption (e.g., a baseline power consumption) of the AIoT device (e.g., in μW), and a type of energy status information (e.g., “energy headroom” or “charging time”).

Based on the parameters in an energy status report configuration and an actual energy level of a capacitor that is implemented in an AIoT device, the AIoT device may determine whether it may perform the triggered procedure or not. Table 3 provides examples for calculating energy consumption per second for different AIoT device implementations. The calculations may be based on an assumption that the capacitor is almost fully charged at 99.3%.

TABLE 3

| | | | | | | Max stored | |
|---|---|---|---|---|---|---|---|
| | | | | | Reference | energy at | Energy |
| | | | | Supply | power | 99.3% | consumption |
| | Device | Capacitance | Resistance | voltage | consumption | capacitance | per second |
| Case | type | size (μF) | (kΩ) | (V) | (μW) | size (μJ) | (μJ) |
| a | 1 | 10 | 100 | 1 | 1 | 5 | 1 |
| b | 2a | 100 | 1000 | 3 | 100 | 450 | 100 |
| c | 2b | 100 | 1000 | 3 | 200 | 450 | 200 |

Upon determining its actual energy status, an AIoT device may transmit some information to the reader in a D2R message in accordance with the received energy status report configuration. For example, the information may include an indication of whether stored energy at the AIoT device is sufficient to perform some triggered procedures or communication (e.g., a single bit indication, where a bit value 0 may correspond to insufficient energy to perform the triggered procedure and a bit value 1 may correspond to sufficient energy to perform the triggered procedure. Additionally, or alternatively, the information may include an indication (e.g., “energy headroom” of length X bits) of how long the actual stored energy may last in time (e.g., a span associated with the stored energy in milliseconds or seconds). Additionally, or alternatively, the information may include an indication (e.g., “charging time” of length Y bits) to indicate a required charging time to reach the capacitance level for performing the triggered procedure (e.g., a charging duration to obtain a capacitance level for performing communications in milliseconds or seconds).

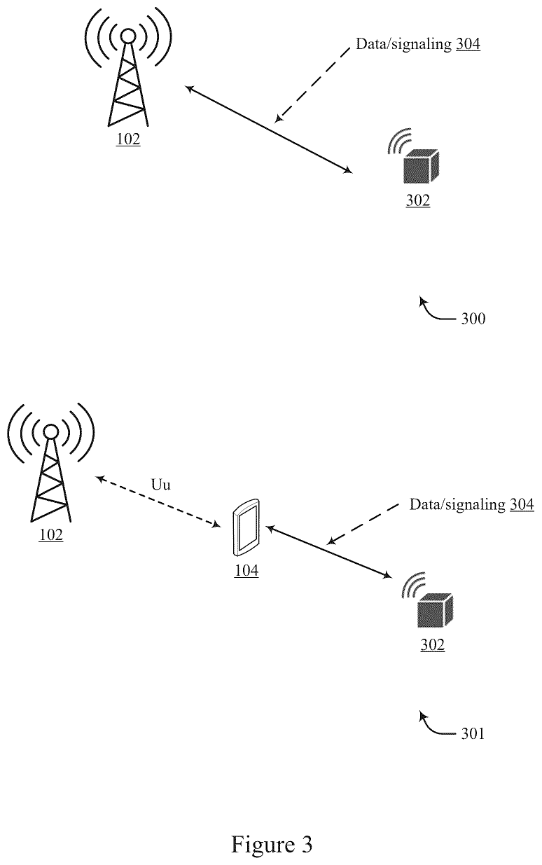

FIG. 3 illustrates an example deployment scenario 300 and a deployment scenario 301 in accordance with aspects of the present disclosure. In this example, the deployment scenarios 300 and 301 may each include an NE 102 (e.g., a base station, a gNB) and an AIoT device 302. In some implementations, the deployment scenario 301 may include a UE 104. The deployment scenarios 300 and 301 may support energy status reporting for AIoT devices, as described herein.

In the deployment scenario 300 (e.g., topology 1), the AIoT device 302 may directionally and bidirectionally communicate with the NE 102, which may serve a micro cell. The communication between the AIoT device 302 and the NE 102 may include AIoT data/signaling 304. In the deployment scenario 300, both the AIoT device 302 and the NE 102 may be located indoors (e.g., a warehouse, a factory, a mall, an airport terminal, and a home, etc.). In some implementations, the NE 102 may be co-sited with other base stations or network devices of other 3GPP technologies.

In the deployment scenario 301 (e.g., topology 2), the AIoT device 302 may communicate bidirectionally with the UE 104, which may be an intermediate node between the AIoT device 302 and the NE 102, where the NE 102 may serve a macro cell. The UE 104 may be capable of supporting AIoT communications, and may transfer AIoT data/signaling 304 between the AIoT device 302 and the NE 102. In the deployment scenario 301, the NE 102 may be located outdoors, and the AIoT device 302 and the UE 104 may be included indoors. In some implementations, the NE 102 may be co-sited with other base stations or network devices of other 3GPP technologies.

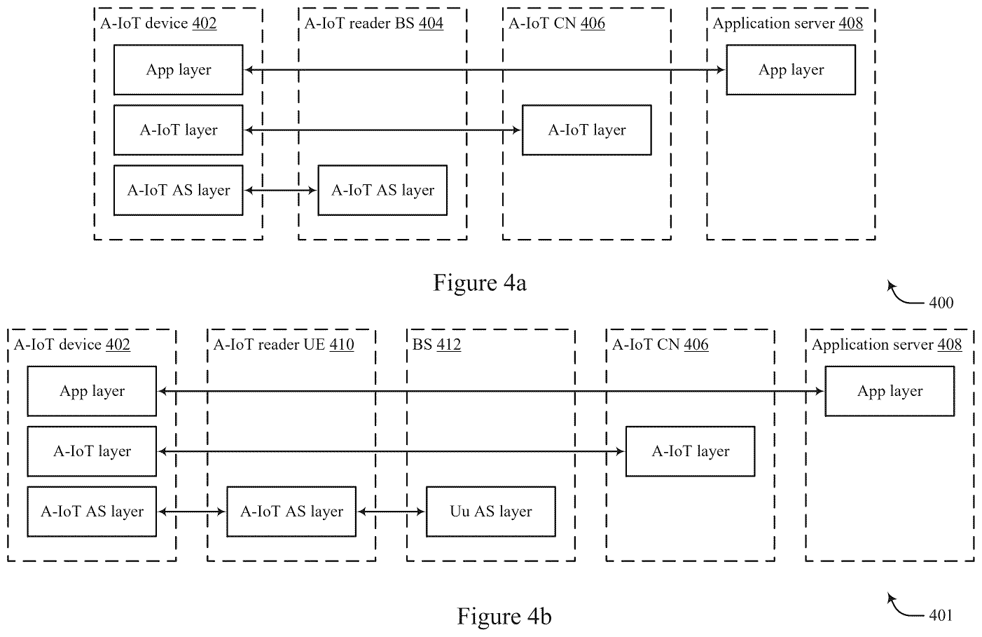

FIGS. 4a and 4b illustrate examples of a protocol stack 400 and a protocol stack 401 in accordance with aspects of the present disclosure. The protocol stack 400 is an example protocol stack architecture corresponding to the deployment scenario 300 (e.g., topology 1) and the protocol stack 401 is an example protocol stack architecture corresponding to the deployment scenario 301 (e.g., topology 2) as described herein with reference to FIG. 3. Considering that AIoT devices may be ultra-low complexity devices with ultra-low power consumption for very low-end IoT applications, the protocol stack architecture for AIoT devices may be more compact than protocol stack architectures specified for NR/5GC systems.

The protocol stack 400 may support communications between an AIoT device 402, an AIoT reader base station (BS) 404 (also referred to herein as a reader, an NE, a base station, a gNB, a wireless communication device), an AIoT CN 406, and an application server 408. An application (App) layer may be used to transmit information between the AIoT device 402 and the application server 408. The application server 408 may reside in an AIoT network or a third-party entity attached to the AIoT network. An AIoT layer may be used to transmit information between the AIoT device 402 and the AIoT CN 406 (e.g., an AMF with AIoT functionality or a new AIoT function). The AIoT access stratum (AS) layer may be used to transmit information between the AIoT device 402 and the AIoT reader base station 404 (e.g., the NE 102 in topology 1 of the deployment scenario 300). The AIoT AS layer may include physical (PHY) and medium access control (MAC) sublayers.

The protocol stack 401 may support communications between an AIoT device 402, an AIoT reader UE 410 (also referred to herein as a reader, a UE, a wireless communication device), a base station 412 (also referred to herein as an NE), an AIoT CN 406, and an application server 408. An application (App) layer may be used to transmit information between the AIoT device 402 and the application server 408. The application server 408 may reside in an AIoT network or a third-party entity attached to the AIoT network. An AIoT layer may be used to transmit information between the AIoT device 402 and the AIoT CN 406 (e.g., an AMF with AIoT functionality or a new AIoT function). The AIoT AS layer may be used to transmit information between the AIoT device 402 and the AIoT reader UE 410 (e.g., the UE 104 in topology 2 of the deployment scenario 301). The AIoT AS layer may include PHY and MAC sublayers. The Uu AS layer may correspond to an existing NR Uu AS layer, and may be used in topology 2 (of the deployment scenario 301) to transmit information between the AIoT reader UE 410 (e.g., the UE 104) and the base station 412 (e.g., the NE 102).

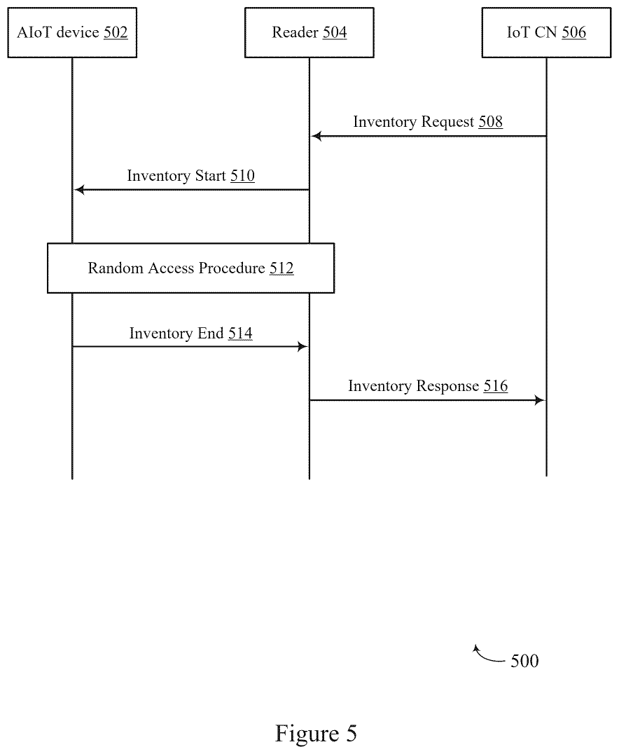

FIG. 5 illustrates an example signaling diagram 500 in accordance with aspects of the present disclosure. In this example, the signaling diagram 500 may include an AIoT device 502, a reader 504, and an AIoT CN 506. The signaling diagram 500 may be for an inventory procedure that may be applied for both indoor and outdoor scenarios. In the signaling diagram 500, it may be assumed that an application server seeks to retrieve an identity of an object (e.g., product or good) that is located in an area of a warehouse. The identity of the object (e.g., an EPC) may be stored in a memory of the AIoT device 502 that is attached to the concerned object. The application server may reside in an AIoT network or a third-party entity attached to the AIoT network. The reader 504 may be an NE (e.g., a base station) or a UE (e.g., an intermediate UE). The AIoT CN 506 may be an AMF with AIoT functionality or a new AIoT function.

At 508, the application server may transmit a request to the AIoT CN 506 to retrieve the EPC of the object that is located in the target area to which the AIoT device 502 (e.g., a target AIoT device) is attached. The request may include information associated with the target area and the AIoT device 502 (e.g., a unique device ID). According to the request received from the application server, the AIoT CN 506 may transmit the inventory request message to the reader 504 that serves the target area. The inventory request message may include the unique device ID of the AIoT device 502.

At 510, the reader 504 may transmit an inventory start message to retrieve the stored EPC from the AIoT device 502 (which is in the target area). The inventory start message may include the unique device ID of the AIoT device 502.

At 512, based on receiving the inventory start message, the AIoT device 502 may perform a random access procedure with the reader 504 to ensure that the stored EPC may be successfully transmitted to the reader 504.

At 514, based on successful completion of the random access procedure, the AIoT device 502 may transmit an inventory end message to the reader 504. The inventory end message may include the stored EPC.

At 516, the reader 504 may transmit an inventory response message to the AIoT CN 506. The inventory response message may include the EPC received from the AIoT device 502. The AIoT CN 506 may then forward the received EPC to the application server.

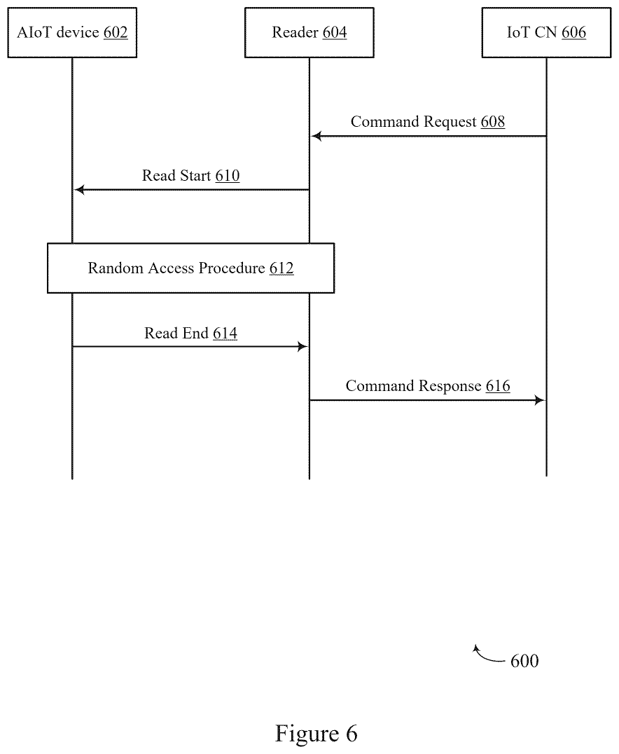

FIG. 6 illustrates an example signaling diagram 600 in accordance with aspects of the present disclosure. In this example, the signaling diagram 600 may include an AIoT device 602, a reader 604, and an AIoT CN 606. The signaling diagram 600 may be for a command procedure, which may be applied for both indoor and outdoor scenarios. It may be assumed that an application server seeks to retrieve data (e.g., other than EPC) of an object that is located in an area of a warehouse. The data may be stored in the memory of the AIoT device 602 that may be attached to the object. The reader 604 may be an NE (e.g., a base station) or a UE (e.g., an intermediate UE). The AIoT CN 606 may be an AMF with AIoT functionality or a new AIoT function.

At 608, the application server may transmit a request to the AIoT CN 606 to retrieve the EPC of the object that is located in the target area to which the AIoT device 602 (e.g., a target AIoT device) is attached. The request may include information associated with the target area, the AIoT device 602, and the type of requested data. According to the request received from the application server, the AIoT CN 606 may transmit a command request message to the reader 604 that serves the target area. The command request message may include information associated with the AIoT device 602 (e.g., its unique device ID) and the type of requested data.

At 610, the reader 604 may transmit a read start message to retrieve the requested type of data from the AIoT device 602 (which is in the target area). The read start message may include the unique device ID of the AIoT device 602 and the requested type of data.

At 612, based on receiving the read start message, the AIoT device 602 may perform a random access procedure with the reader 604 to ensure that the requested type of data may be successfully transmitted to the reader 604.

At 614, based on successful completion of the random access procedure, the AIoT device 602 may transmit a read end message to the reader 604. The read end message may include the requested type of data.

At 616, the reader 604 may transmit a command response message to the AIoT CN 606. The command response message may include the requested type of data received from the AIoT device 602. The AIoT CN 606 may then forward the received requested type of data to the application server.

The procedures for inventory (described in the signaling diagram 500 of FIG. 5) and command (described in the signaling diagram 600 of FIG. 6) are not mutually exclusive and may be combined. For example, the inventory and command procedures may be performed in sequence.

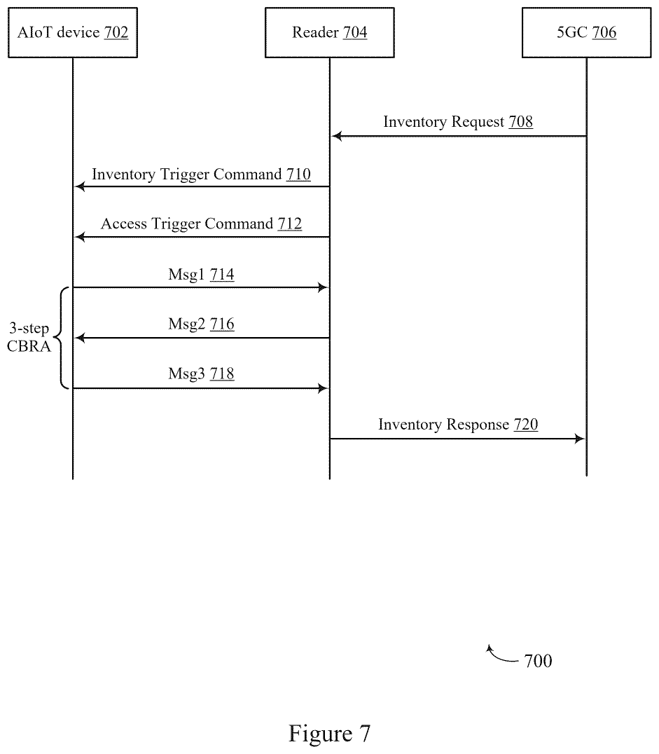

FIG. 7 illustrates an example signaling diagram 700 in accordance with aspects of the present disclosure. In some examples, the signaling diagram 700 may implement aspects of the wireless communications system 100, the deployment scenarios 300 and 301, and the protocol stacks 400 and 401. The signaling diagram 700 may be implemented by an AIoT device 702, a reader 704, and a 5GC 706, which may be examples of corresponding devices described herein. For example, the reader 704 may be an NE 102 (e.g., according to topology 1 of the deployment scenario 300) or a UE 104 (e.g., an intermediate UE according to topology 2 of deployment scenario 301), and may also be referred to herein as a wireless communication device. The AIoT device 702 may also be referred to herein as an IoT device. The 5GC 706 may be an AMF with AIoT functionality or a new AIoT function. Alternative examples of the following may be implemented, where some processes are performed in a different order than described or are not performed. In some cases, processes may include additional features not mentioned below, or further processes may be added.

Regarding the signaling diagram 700, it may be assumed that the 5GC 706 triggers an initial inventory procedure to take inventory all AIoT devices 702 that are located in a geographical area (e.g., in an area of a warehouse). Accordingly, the signaling diagram 700 may include one or multiple AIoT devices 702.

At 708, the 5GC 706 may transmit an inventory request message to the reader 704 that serves the target area. The inventory request message may include a unique device ID of the AIoT device 702 (e.g., a target AIoT device).

At 710, the reader 704 may transmit an R2D message to the AIoT device 702 that includes an inventory trigger command. The inventory trigger command may include the unique device ID corresponding to the AIoT device 702 and an energy status report configuration. Parameters in the energy status report configuration may include a reference duration of the triggered procedure (e.g., 1 second), a reference power consumption, such as a baseline power consumption (e.g., 1 μW for an AIoT device type 1, 100 μW for an AIoT device type 2a, 200 μW for an AIoT device type 2b), and a type of energy status information (e.g., “energy headroom”). Upon reception of the inventory trigger command, the AIoT device 702 may determine its actual energy status based on the received energy status report configuration. It may be assumed that the AIoT device has sufficient energy to perform the triggered procedure.

At 712, the reader 704 may transmit an R2D message to the AIoT device 702 that includes an access trigger command. The access trigger command may indicate an access occasion for starting a random access procedure. It may be assumed that a 3-step CBRA procedure may be performed between the reader 704 and the AIoT device 702 (e.g., which may include communication of a Msg1, a Msg2, and a Msg3 as described herein).

At 714, the AIoT device 702 may transmit a Msg1 to the reader 704 including a random ID (e.g., a 16-bit value) that the AIoT device 702 generated.

At 716, in the case that the reader 704 successfully receives the Msg1 from the AIoT device 702, the reader 704 may echo (e.g., forward, transmit, output) the received random ID in a Msg2 to the AIoT device 702.

At 718, based on receiving the Msg2, the AIoT device 702 may transmit a Msg3 to the reader 704. The Msg3 may include an EPC associated with the AIoT device 702 and the energy status report. In addition, based on the energy status report configuration, the AIoT device 702 may determine its actual energy status based on receiving the Msg2. In some implementations, the AIoT device 702 may be of an AIoT device type 2a and may implemented according to case b in Table 3 (e.g., the AIoT device 702 may be equipped with a capacitance size of 100 μF, and 350 uJ may be available in its capacitor). As a result, the AIoT device 702 may transmit the energy headroom information in the energy status report (e.g., “energy headroom”=3.5 seconds) assuming an average energy consumption of the AIoT device 702 per second which may vary according to the device type.

At 720, the reader 704 may transmit an inventory response message to the 5GC 706, which may include the EPC and the energy status report received from the AIoT device 702. The 5GC 706 may use the energy status information for a subsequent command procedure. In one implementation, the reader 704 may configure the AIoT device 702 with a duty cycle or monitoring occasions for subsequent command messages or any other type of messages according to the received energy status information.

In some implementations, if the AIoT device determines that it has insufficient energy to perform the triggered procedure after reception of the inventory trigger command from the reader 704, then the AIoT device may omit 712, (reception of the access trigger command), 714 (transmission of Msg1), 716 (e.g., reception of Msg2) and 718 (e.g., transmission of Msg3).

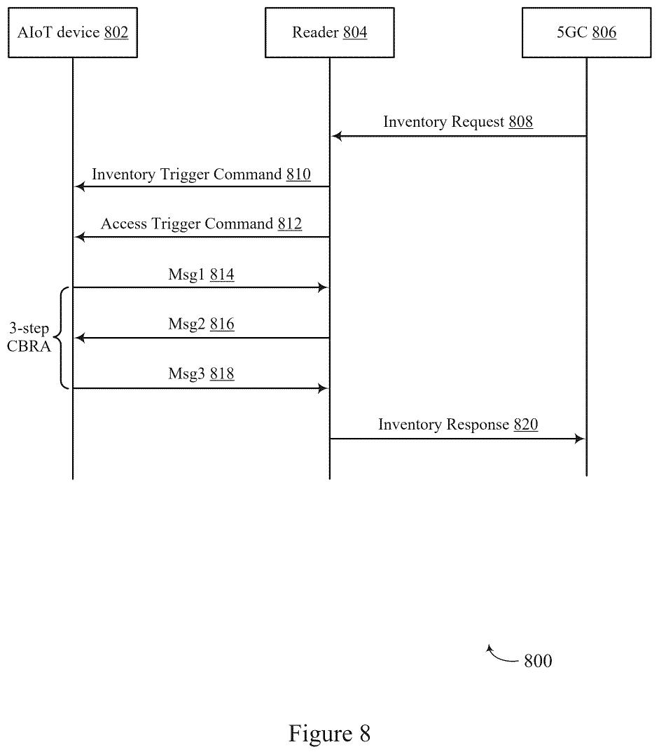

FIG. 8 illustrates an example signaling diagram 800 in accordance with aspects of the present disclosure. In some examples, the signaling diagram 800 may implement aspects of the wireless communications system 100, the deployment scenarios 300 and 301, and the protocol stacks 400 and 401. The signaling diagram 800 may be implemented by an AIoT device 802, a reader 804, and a 5GC 806, which may be examples of corresponding devices described herein. For example, the reader 804 may be an NE 102 (e.g., according to topology 1 of the deployment scenario 300) or a UE 104 (e.g., an intermediate UE according to topology 2 of deployment scenario 301), and may also be referred to herein as a wireless communication device. The AIoT device 802 may also be referred to herein as an IoT device. The 5GC 806 may be an AMF with AIoT functionality or a new AIoT function. Alternative examples of the following may be implemented, where some processes are performed in a different order than described or are not performed. In some cases, processes may include additional features not mentioned below, or further processes may be added.

Regarding the signaling diagram 800, it may be assumed that the 5GC 806 triggers an initial inventory procedure to take inventory all AIoT devices 802 that are located in a geographical area (e.g., in an area of a warehouse). Accordingly, the signaling diagram 800 may include one or multiple AIoT devices 802.

At 808, the 5GC 806 may transmit an inventory request message to the reader 804 that serves the target area. The inventory request message may include a unique device ID of the AIoT device 802 (e.g., a target AIoT device).

At 810, the reader 804 may transmit an R2D message to the AIoT device 802 that includes an inventory trigger command. The inventory trigger command may include the unique device ID corresponding to the AIoT device 802 and an energy status report configuration. Parameters in the energy status report configuration may include a reference duration of the triggered procedure (e.g., 1 second), a reference power consumption, such as a baseline power consumption (e.g., 1 μW for an AIoT device type 1, 100 μW for an AIoT device type 2a, 200 μW for an AIoT device type 2b), and a type of energy status information (e.g., “energy headroom”). Upon reception of the inventory trigger command, the AIoT device 802 may determine its actual energy status based on the received energy status report configuration. It may be assumed that the AIoT device has sufficient energy to perform the triggered procedure.

At 812, the reader 804 may transmit an R2D message to the AIoT device 802 that includes an access trigger command. The access trigger command may indicate an access occasion for starting a random access procedure. It may be assumed that a 3-step CBRA procedure may be performed between the reader 804 and the AIoT device 802 (e.g., which may include communication of a Msg1, a Msg2, and a Msg3 as described herein).

At 814, the AIoT device 802 may transmit a Msg1 to the reader 804 including a random ID (e.g., a 16-bit value) that the AIoT device 802 generated and including the energy status report. In addition, based on the energy status report configuration, the AIoT device 802 may determine its actual energy status. Depending on an AIoT device type and an implementation of the AIoT device 802 according to Table 3, the AIoT device 802 may transmit the following information in the energy status report: If the AIoT device 802 is an AIoT device type 1, “energy headroom”=0.8 seconds; if the AIoT device 802 is an AIoT device type 2a, “energy headroom”=4 seconds; if the AIoT device 802 is an AIoT device type 2b, “energy headroom”=2 seconds.

At 816, in the case that the reader 804 successfully receives the Msg1 from the AIoT device 802, and based on the received energy status report, the reader 804 may determine whether to echo (e.g., forward, transmit, output) the received random ID in a Msg2 to the AIoT device 802 or to transmit a negative acknowledgment (NACK) as a response. In some implementations, the reader 804 may echo the random ID in the Msg2 if the AIoT device 802 is energy limited. Alternatively, the reader 804 may transmit a NACK if the AIoT device 802 is not energy limited. In such cases, the reader 804 may serve and prioritize AIoT devices 802 that are energy-limited during an inventory procedure. AIoT devices 802 that are not energy limited may receive a NACK, and subsequently may draw a random number and select a new access occasion for transmitting the Msg1 based on the drawn random number.

At 818, based on receiving the Msg2, the AIoT device 802 may transmit a Msg3 to the reader 804 if the AIoT device 802 is an AIoT device type 1. The Msg3 may include the EPC associated with the AIoT device.

At 820, the reader 804 may transmit an inventory response message to the 5GC 806 that includes the EPC received from the AIoT device. In some implementations, if the AIoT device determines that it has insufficient energy to perform the triggered procedure after reception of the inventory trigger command from the reader 804, then the AIoT device may omit 812, (reception of the access trigger command), 814 (transmission of Msg1), 816 (e.g., reception of Msg2) and 818 (e.g., transmission of Msg3).

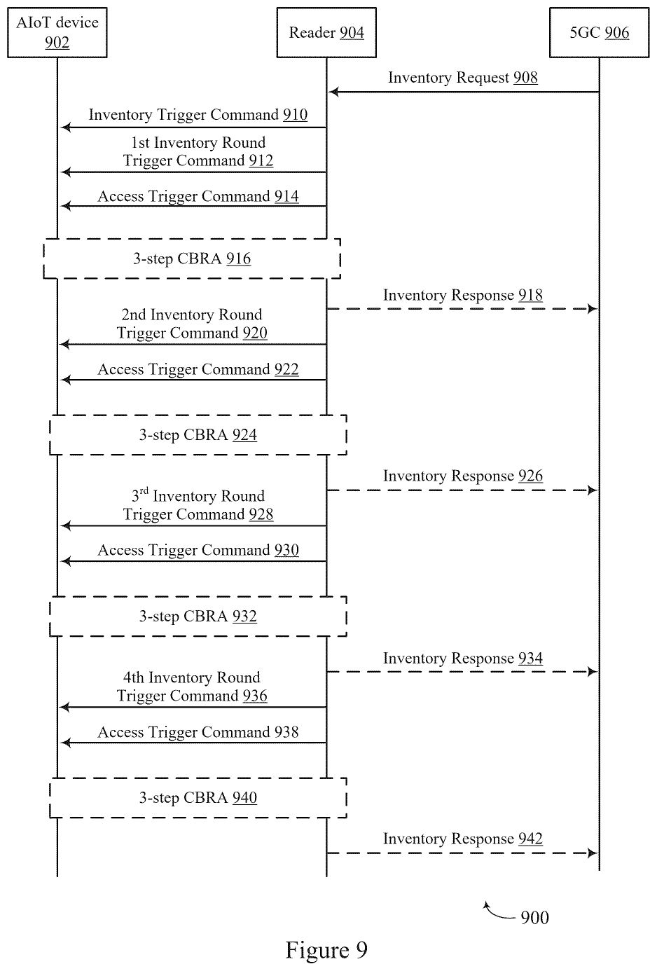

FIG. 9 illustrates an example signaling diagram 900 in accordance with aspects of the present disclosure. In some examples, the signaling diagram 900 may implement aspects of the wireless communications system 100, the deployment scenarios 300 and 301, and the protocol stacks 400 and 401. The signaling diagram 900 may be implemented by an AIoT device 902, a reader 904, and a 5GC 906, which may be examples of corresponding devices described herein. For example, the reader 904 may be an NE 102 (e.g., according to topology 1 of the deployment scenario 300) or a UE 104 (e.g., an intermediate UE according to topology 2 of deployment scenario 301), and may also be referred to herein as a wireless communication device. The AIoT device 902 may also be referred to herein as an IoT device. The 5GC 906 may be an AMF with AIoT functionality or a new AIoT function. Alternative examples of the following may be implemented, where some processes are performed in a different order than described or are not performed. In some cases, processes may include additional features not mentioned below, or further processes may be added.

Regarding the signaling diagram 900, it may be assumed that the 5GC 906 may trigger an initial inventory procedure to take inventory all AIoT devices 902 that are located within a geographical area (e.g., in an area of a warehouse). For example, there may be one hundred target AIoT devices 902 of different device types and implementations according to Table 3. Accordingly, the signaling diagram 900 may include one or multiple AIoT devices 902. To serve the different AIoT device types and implementations based on their actual energy statuses during an inventory procedure, the procedure may be separated into a number of inventory rounds (e.g., four rounds). In one implementation, the term inventory round may be referred to as access round.

At 908, the 5GC 906 may transmit an inventory request message to the reader 904 that serves a target area. The inventory request message may include a list of unique device IDs corresponding to the AIoT devices 902 (e.g., target AIoT devices).

At 910, the reader 904 may transmit an R2D message to the AIoT devices 802 that includes an inventory trigger command. The inventory trigger command may include a list of unique device IDs corresponding to the AIoT devices 802 (e.g., target AIoT devices), the number of configured inventory rounds, and the energy status report configuration. The energy status report configuration may include parameters such as a reference duration of the triggered procedure (e.g., 8 seconds overall) and a reference power consumption, such as a baseline power consumption (e.g., 1 W for an AIoT device type 1, 100 μW for an AIoT device type 2a, 200 μW for an AIoT device type 2b).

The AIoT devices 802 may determine a reference duration for each inventory round by dividing a reference duration of the triggered procedure by four (e.g., where a reference duration for each inventory round may be two seconds). Based on receiving the inventory trigger command, the AIoT devices 902 may determine their actual energy statuses based on the received energy status report configuration. In some examples, some of the AIoT devices 902 that are targeted may lack sufficient energy to perform the triggered procedure according to the configured reference duration of eight seconds. As such, the AIoT devices 902 may use their respective determined actual energy status to select an inventory round for accessing the reader 904.

At 912, the reader 904 may transmit an R2D message to the AIoT devices 902 that includes a trigger command for a first inventory round.

At 914, the reader 904 may transmit an R2D message to the AIoT devices 902 that includes an access trigger command to indicate one or more access occasions for starting a 3-step CBRA procedure for the first inventory round.

At 916, each AIoT device 902 that has sufficient energy for accessing the reader during the first inventory round may select the first inventory round and perform a 3-step CBRA procedure with the reader. The 3-step CBRA procedure may include communication of a Msg1, a Msg2, and a Msg3 as described herein with reference to FIGS. 7 and 8.

At 918, the reader 904 may transmit an inventory response message to the 5GC 906 that includes the EPCs corresponding to the AIoT devices which were successfully received during the first inventory round.

At 920, the reader 904 may transmit an R2D message to the AIoT devices 902 that includes the trigger command for a second inventory round. The AIoT devices 902 may select the second inventory round according to their actual energy status.

At 922, the reader 904 may transmit an R2D message to the AIoT devices 902 that includes an access trigger command to indicate one or more access occasions for starting a 3-step CBRA procedure for the second inventory round.

At 924, each AIoT device 902 that has sufficient energy for accessing the reader during the second inventory round may select the second inventory round and perform a 3-step CBRA procedure with the reader 904. The 3-step CBRA procedure may include communication of a Msg1, a Msg2, and a Msg3 as described herein with reference to FIGS. 7 and 8.

At 926, the reader 904 may transmit an inventory response message to the 5GC 906 that includes EPCs corresponding to AIoT devices 902 that were successfully received during the second inventory round.

At 928, the reader 904 may transmit an R2D message to the AIoT devices 902 that includes the trigger command for a third inventory round. The AIoT devices 902 may select the third inventory round according to their actual energy status.

At 930, the reader 904 may transmit an R2D message to the AIoT devices 902 that includes an access trigger command to indicate one or more access occasions for starting a 3-step CBRA procedure for the third inventory round.

At 932, each AIoT device 902 that has sufficient energy for accessing the reader during the third inventory round may select the third inventory round and perform a 3-step CBRA procedure with the reader 904. The 3-step CBRA procedure may include communication of a Msg1, a Msg2, and a Msg3 as described herein with reference to FIGS. 7 and 8.

At 934, the reader 904 may transmit an inventory response message to the 5GC 906 that includes EPCs corresponding to AIoT devices 902 that were successfully received during the third inventory round.

At 936, the reader 904 may transmit an R2D message to the AIoT devices 902 that includes the trigger command for a fourth inventory round. The AIoT devices 902 may select the fourth inventory round according to their actual energy status.

At 938, the reader 904 may transmit an R2D message to the AIoT devices 902 that includes an access trigger command to indicate one or more access occasions for starting a 3-step CBRA procedure for the fourth inventory round.

At 940, each AIoT device 902 that has sufficient energy for accessing the reader during the fourth inventory round may select the fourth inventory round and perform a 3-step CBRA procedure with the reader 904. The 3-step CBRA procedure may include communication of a Msg1, a Msg2, and a Msg3 as described herein with reference to FIGS. 7 and 8.

At 942, the reader 904 may transmit an inventory response message to the 5GC 906 that includes EPCs corresponding to AIoT devices 902 that were successfully received during the fourth inventory round.

In some implementations, if all of the AIoT devices 902 that are targeted have sufficient energy to perform the triggered procedure according to the configured reference duration of eight seconds, the AIoT devices 902 may randomly select an inventory round for accessing the reader 904.

Alternatively, the reader 904 may include multiple values of a parameter for distributing the AIoT devices 902 to available inventory rounds and access occasions within an inventory round based on their actual energy statuses. The parameter (e.g., a Q value) may be an integer value, where Q=4 may apply for the first inventory round, Q=8 may apply for the second inventory round, Q=16 may apply for the third inventory round, and Q=32 may apply for the fourth inventory round. The AIoT devices 902 may apply the Q value that is associated with their selected inventory round.

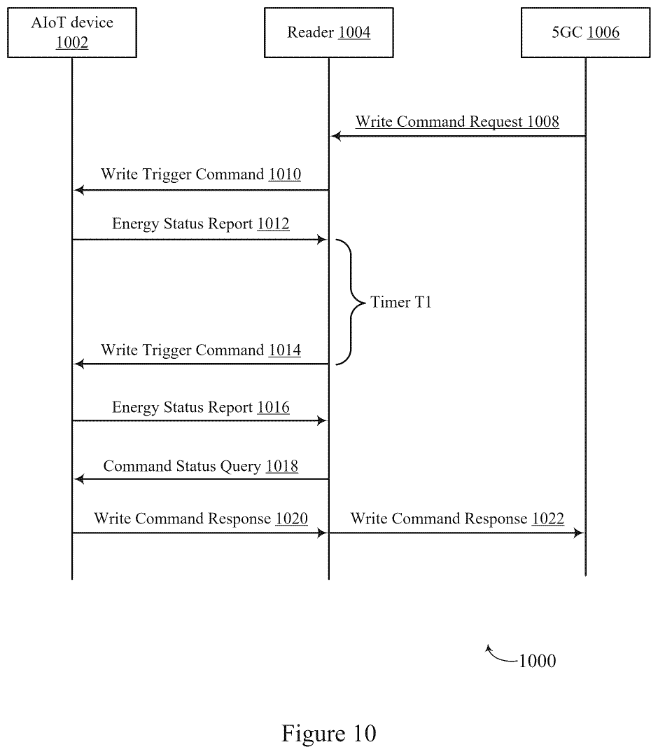

FIG. 10 illustrates an example signaling diagram 1000 in accordance with aspects of the present disclosure. In some examples, the signaling diagram 1000 may implement aspects of the wireless communications system 100, the deployment scenarios 300 and 301, and the protocol stacks 400 and 401. The signaling diagram 1000 may be implemented by an AIoT device 1002, a reader 1004, and a 5GC 1006, which may be examples of corresponding devices described herein. For example, the reader 1004 may be an NE 102 (e.g., according to topology 1 of the deployment scenario 300) or a UE 104 (e.g., an intermediate UE according to topology 2 of deployment scenario 301), and may also be referred to herein as a wireless communication device. The AIoT device 1002 may also be referred to herein as an IoT device. The 5GC 1006 may be an AMF with AIoT functionality or a new AIoT function. Alternative examples of the following may be implemented, where some processes are performed in a different order than described or are not performed. In some cases, processes may include additional features not mentioned below, or further processes may be added.

Regarding the signaling diagram 1000, it may be assumed that the 5GC 1006 has already performed an initial inventory procedure to take inventory all AIoT devices 1002 that are located within a geographical area (e.g., in an area of a warehouse). As a result of the initial inventory procedure, the 5GC 1006 may know the identities (e.g., EPCs) of the AIoT devices 1002 that are located within the area. In a subsequent command procedure, the 5GC 1006 may seek to write location information (e.g., X, Y, Z values according to the Cartesian coordinate system) into the memory of each AIoT device 1002 that was inventoried. The AIoT device 1002 in the signaling diagram 1000 may show a single target AIoT device 1002 of AIoT device type 2a that may be implemented according to case b in Table 3.

At 1008, the 5GC 1006 may transmit a write command request message to the reader 1004 that serves the target area. The write command request message may include information associated with the AIoT device 1002 (e.g., a target AIoT device) and its location information (e.g., X, Y, Z values according to the Cartesian coordinate system).

At 1010, the reader 1004 may transmit an R2D message to the AIoT device 1002 that includes a write trigger command. The write trigger command may include a unique device ID corresponding to the AIoT device 1002 (e.g., its unique device ID), the location information, and an energy status report configuration. The energy status report configuration may include parameters such as a reference duration of the triggered procedure (e.g., 1 second), a reference power consumption, such as a baseline power consumption (e.g., 100 μW for an AIoT device type 2a), and a type of energy status information (e.g., “charging time”).

At 1012, based on receiving the R2D message, the AIoT device 1002 may determine its actual energy status based on the received energy status report configuration. In some implementations, the AIoT device may lack sufficient energy to perform the triggered write command procedure, except for transmitting the energy status report. As a result, the AIoT device 1002 may transmit a D2R message to the reader 1004 that may include the energy status report with a value “insufficient energy” and a required charging time to perform the triggered write command procedure (e.g., 10 seconds). In some examples, the AIoT device 1002 may discard the received write trigger command.

At 1014, in accordance with the received energy status report from the AIoT device 1002, the reader 1004 may start a timer T1. When the timer T1 expires, the reader 1004 may transmit a new R2D message to the AIoT device 1002 that includes a write trigger command (similar to the write trigger command at 1010). The reader 1004 may set a value of the timer T1 according to the required charging time of 10 seconds received from the AIoT device 1002.

At 1016, based on receiving the new R2D message, the AIoT device 1002 may determine its actual energy status based on the received energy status report configuration. In such examples, the AIoT device 1002 was able to harvest sufficient energy during the time T1. In addition, the AIoT device 1002 may have sufficient energy to perform the triggered write command. As a result, the AIoT device 1002 may transmit a D2R message to the reader 1004 that includes an energy status report with a value “sufficient energy” and begins processing the received write command (e.g., writing the received location information into its memory).

At 1018, if the reader 1004 fails to receive a response from the A-IoT device after a particular period of time, the reader 1004 may transmit an R2D message that includes a command status query.

At 1020, if the AIoT device 1002 completed the write operation, the AIoT device 1002 may transmit a D2R message to the reader 1004 that includes a write command response for confirming the successful write operation.

At 1022, the reader 1004 may forward the received write command response to the 5GC 1006.

In some implementations, if the AIoT device 1002 transmits an energy status report with a value “sufficient energy” at 1012, the AIoT device 1002 may omit 1014 (receiving the write trigger command) and 1016 (transmitting the energy status report).

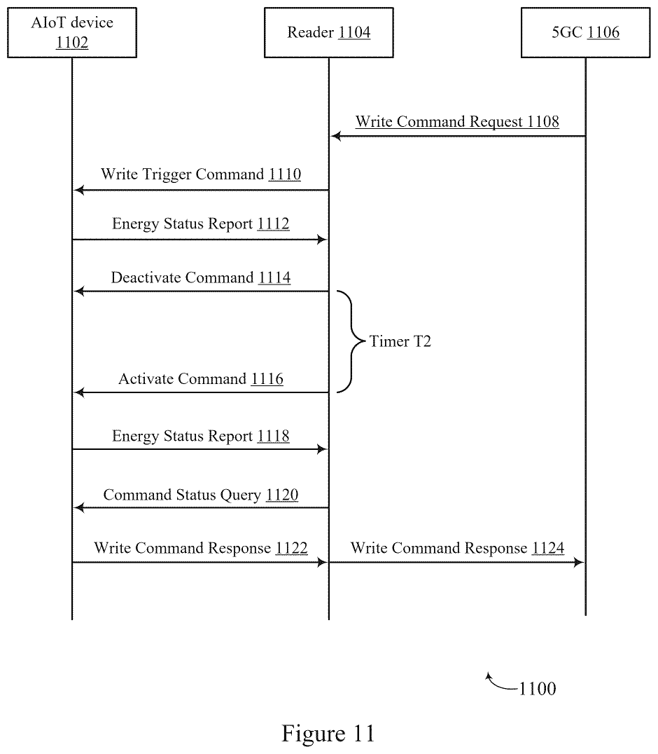

FIG. 11 illustrates an example signaling diagram 1100 in accordance with aspects of the present disclosure. In some examples, the signaling diagram 1100 may implement aspects of the wireless communications system 100, the deployment scenarios 300 and 301, and the protocol stacks 400 and 401. The signaling diagram 1100 may be implemented by an AIoT device 1102, a reader 1104, and a 5GC 1106, which may be examples of corresponding devices described herein. For example, the reader 1104 may be an NE 102 (e.g., according to topology 1 of the deployment scenario 300) or a UE 104 (e.g., an intermediate UE according to topology 2 of deployment scenario 301), and may also be referred to herein as a wireless communication device. The AIoT device 1102 may also be referred to herein as an IoT device. The 5GC 1106 may be an AMF with AIoT functionality or a new AIoT function. Alternative examples of the following may be implemented, where some processes are performed in a different order than described or are not performed. In some cases, processes may include additional features not mentioned below, or further processes may be added.

Regarding the signaling diagram 1100, it may be assumed that the 5GC 1106 has already performed an initial inventory procedure to take inventory all AIoT devices 1102 that are located within a geographical area (e.g., in an area of a warehouse). As a result of the initial inventory procedure, the 5GC 1106 may know the identities (e.g., EPCs) of the AIoT devices 1102 that are located within the area. In a subsequent command procedure, the 5GC 1106 may seek to write location information (e.g., X, Y, Z values according to the Cartesian coordinate system) into the memory of each AIoT device 1102 that was inventoried. The AIoT device 1102 in the signaling diagram 1100 may show a single target AIoT device 1102 of AIoT device type 2a that may be implemented according to case b in Table 3.

At 1108, the 5GC 1106 may transmit a write command request message to the reader 1104 that serves the target area. The write command request message may include information associated with the AIoT device 1102 (e.g., a target AIoT device) and its location information (e.g., X, Y, Z values according to the Cartesian coordinate system).

At 1110, the reader 1104 may transmit an R2D message to the AIoT device 1102 that includes a write trigger command. The write trigger command may include a unique device ID corresponding to the AIoT device 1102 (e.g., its unique device ID), the location information, and an energy status report configuration. The energy status report configuration may include parameters such as a reference duration of the triggered procedure (e.g., 1 second), a reference power consumption, such as a baseline power consumption (e.g., 100 μW for an AIoT device type 2a), and a type of energy status information (e.g., “charging time”).

At 1112, based on receiving the R2D message, the AIoT device 1102 may determine its actual energy status based on the received energy status report configuration. In some implementations, the AIoT device may lack sufficient energy to perform the triggered write command procedure, except for transmitting the energy status report and receiving a further R2D message. As a result, the AIoT device 1102 may transmit a D2R message to the reader 1104 that may include the energy status report with a value “insufficient energy” and a required charging time to perform the triggered write command procedure (e.g., 10 seconds). In some examples, the AIoT device 1102 may maintain (e.g., keep) the received write trigger command while harvesting energy.

At 1114, in accordance with the received energy status report from the AIoT device 1102, the reader 1104 may transmit an R2D message that includes a deactivate command to instruct the AIoT device 1102 to move (e.g., transfer, transition) to a “deactivate” state (e.g., from an “active” state). The deactivate command may also include a time value T2 that indicates a minimum time for the AIoT device 1102 to stay in the “deactivate” state. Both the reader 1104 and the AIoT device 1102 may start the timer T2. The reader 1104 may set a value of the timer T2 according to the required charging time of 10 seconds received from the AIoT device 1102.

At 1116, when the timer T2 expires, the AIoT device 1102 may monitor a downlink for an R2D message including an activate command. That is, the AIoT device 1102 in the “deactivate” state may refrain from acting on an R2D message that does contain any other type of command. Based on expiration of the timer T2, the reader 1104 may transmit an R2D message to the AIoT device 1102 that includes the activate command to instruct the AIoT device 1102 to move (e.g., transfer, transition) to an “activate” state.

At 1118, based on receiving the R2D message at 1116, the AIoT device 1102 may determine its actual energy status based on the received energy status report configuration. In such examples, the AIoT device 1102 was able to harvest sufficient energy during the time T2. Alternatively, the reader 1104 may transmit a new energy status report configuration to the AIoT device 1102 in the activate command. In such cases, the AIoT device 1102 may determine its actual energy status based on the new energy status report configuration. Here, the AIoT device 1102 may have sufficient energy to perform the triggered write command procedure. As a result, the AIoT device 1102 may transmit a D2R message to the reader 1104 that may include an energy status report with a value “sufficient energy” and start processing the received write command (e.g., writing the received location information into its memory).

At 1120, if the reader 1104 fails to receive a response from the A-IoT device after a particular period of time, the reader 1104 may transmit an R2D message that includes a command status query.

At 1122, if the AIoT device 1102 completed the write operation, the AIoT device 1102 may transmit a D2R message to the reader 1104 that includes a write command response for confirming the successful write operation.

At 1124, the reader 1104 may forward the received write command response to the 5GC 1106.

In some implementations, if the AIoT device 1102 transmits an energy status report with a value “sufficient energy” at 1112, the AIoT device 1102 may omit 1114 (receiving the deactivate command), 1116 (receiving the activate command), and 1118 (e.g., transmitting the energy status report).

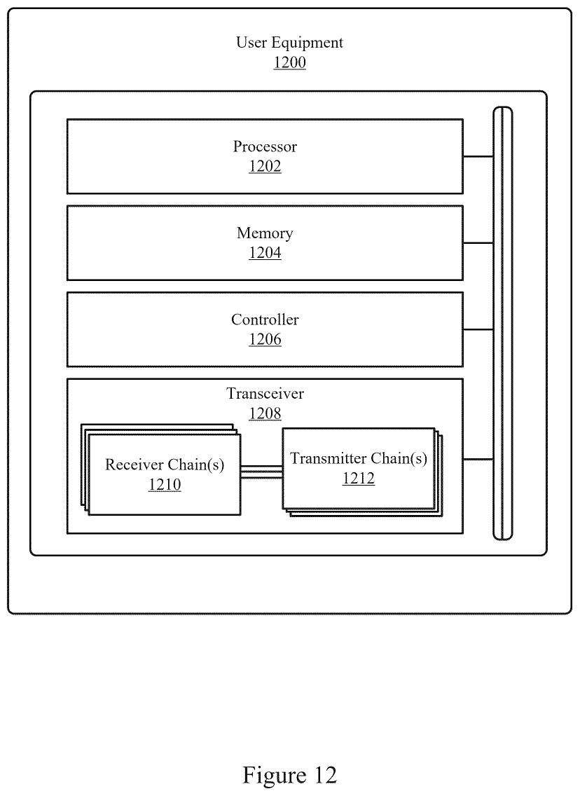

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for transmitting, to an IoT device, a first message that includes a set of one or more parameters associated with an energy status of the IoT device; and receiving, from the IoT device, a second message that includes information associated with the energy status of the IoT device based at least in part on the set of one or more parameters.

Additionally, the UE 1200 may be configured to support any one or combination of initiating communications with the IoT device based at least in part on the transmitted first message; wherein the set of one or more parameters comprises one or more of a reference duration, a reference power consumption of the IoT device, or a type of the information associated with the energy status.

Additionally, or alternatively, the UE 1200 may be configured to support any one or combination of transmitting, based at least in part on the energy status, a third message that triggers the IoT device to switch from a first state to a second state, wherein the first state comprises an active state, and wherein the second state comprises a deactive state; initiating a timer that suspends communication with the IoT device based at least in part on the information; and transmitting, to the IoT device, a third message that resumes the communication with the IoT device based at least in part on an expiration of the timer; and wherein the wireless communication device comprises a UE 1200 or an NE.

Additionally, or alternatively, the UE 1200 may support at least one memory (e.g., the memory 1204) and at least one processor (e.g., the processor 1202) coupled with the at least one memory and configured to cause the UE 1200 to transmit, to an IoT device, a first message that includes a set of one or more parameters associated with an energy status of the IoT device; and receive, from the IoT device, a second message that includes information associated with the energy status of the IoT device based at least in part on the set of one or more parameters

Additionally, the UE 1200 may be configured to support any one or combination initiating communication with the IoT device based at least in part on the transmitted first message; wherein the set of one or more parameters comprises one or more of a reference duration, a reference power consumption of the IoT device, or a type of the information associated with the energy status.

Additionally, or alternatively, the UE 1200 may be configured to support any one or combination of transmitting, to the IoT device, a third message that schedules an occasion for communication with the IoT device based at least in part on the information; transmitting, based at least in part on the energy status, a third message that triggers the IoT device to switch from a first state to a second state, wherein the first state comprises an active state, and wherein the second state comprises a deactive state; initiating a timer that suspends communication with the IoT device based at least in part on the information; and transmitting, to the IoT device, a third message that resumes the communication with the IoT device based at least in part on an expiration of the timer; and wherein the wireless communication device comprises a UE 1200 or an NE.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

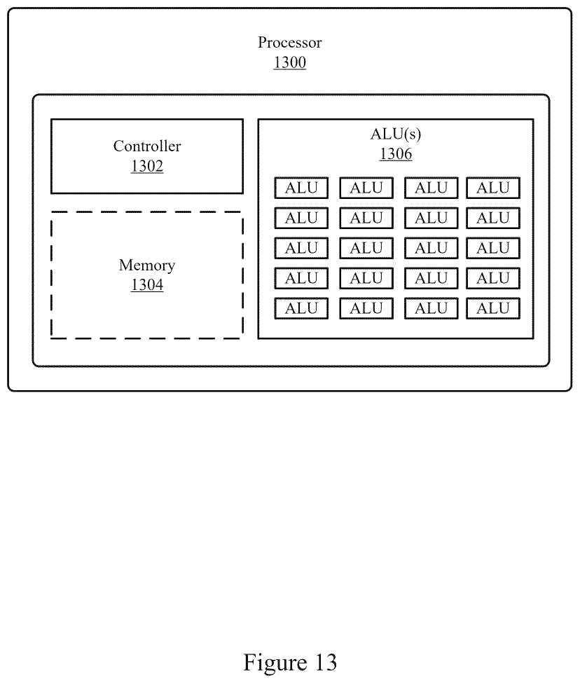

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to transmit, to an IoT device, a first message that includes a set of one or more parameters associated with an energy status of the IoT device; and receive, from the IoT device, a second message that includes information associated with the energy status of the IoT device based at least in part on the set of one or more parameters.

Additionally, the processor 1300 may be configured to or operable to support any one or initiating communication with the IoT device based at least in part on the transmitted first message; wherein the set of one or more parameters comprises one or more of a reference duration, a reference power consumption of the IoT device, or a type of the information associated with the energy status.

Additionally, or alternatively, the processor 1300 may be configured to or operable to support any one or combination of transmitting, to the IoT device, a third message that schedules an occasion for communication with the IoT device based at least in part on the information; transmitting, based at least in part on the energy status, a third message that triggers the IoT device to switch from a first state to a second state, wherein the first state comprises an active state, and wherein the second state comprises a deactive state; initiating a timer that suspends communication with the IoT device based at least in part on the information; and transmitting, to the IoT device, a third message that resumes the communication with the IoT device based at least in part on an expiration of the timer; and wherein the wireless communication device comprises a UE 1200 or an NE.

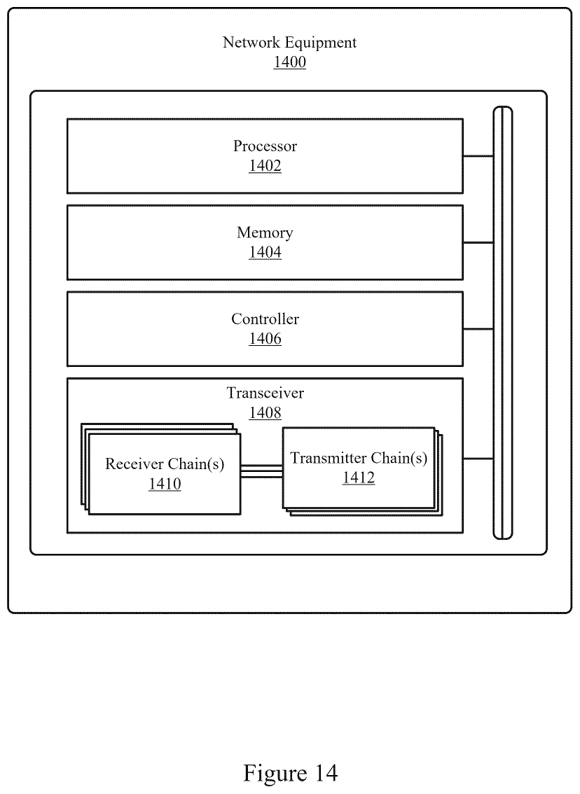

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting, to an IoT device, a first message that includes a set of one or more parameters associated with an energy status of the IoT device; and receiving, from the IoT device, a second message that includes information associated with the energy status of the IoT device based at least in part on the set of one or more parameters.

Additionally, the NE 1400 may be configured to support any one or combination of initiating communications with the IoT device based at least in part on the transmitted first message; wherein the set of one or more parameters comprises one or more of a reference duration, a reference power consumption of the IoT device, or a type of the information associated with the energy status.

Additionally, or alternatively, the NE 1400 may be configured to support any one or combination of transmitting, to the IoT device, a third message that schedules an occasion for communication with the IoT device based at least in part on the information; transmitting, based at least in part on the energy status, a third message that triggers the IoT device to switch from a first state to a second state, wherein the first state comprises an active state, and wherein the second state comprises a deactive state; initiating a timer that suspends communication with the IoT device based at least in part on the information; and transmitting, to the IoT device, a third message that resumes the communication with the IoT device based at least in part on an expiration of the timer; and wherein the wireless communication device comprises a UE or an NE 1400.

Additionally, or alternatively, the NE 1400 may support at least one memory (e.g., the memory 1404) and at least one processor (e.g., the processor 1402) coupled with the at least one memory and configured to cause the NE 1400 to transmit, to an IoT device, a first message that includes a set of one or more parameters associated with an energy status of the IoT device; and receive, from the IoT device, a second message that includes information associated with the energy status of the IoT device based at least in part on the set of one or more parameters.

Additionally, the NE 1400 may be configured to support any one or combination of wherein the first message initiating communications with the IoT device based at least in part on the transmitted first message; wherein the set of one or more parameters comprises one or more of a reference duration, a reference power consumption of the IoT device, or a type of the information associated with the energy status.

Additionally, or alternatively, the NE 1400 may be configured to support any one or combination of transmitting, to the IoT device, a third message that schedules an occasion for communication with the IoT device based at least in part on the information; transmitting, based at least in part on the energy status, a third message that triggers the IoT device to switch from a first state to a second state, wherein the first state comprises an active state, and wherein the second state comprises a deactive state; initiating a timer that suspends communication with the IoT device based at least in part on the information; and transmitting, to the IoT device, a third message that resumes the communication with the IoT device based at least in part on an expiration of the timer; and wherein the wireless communication device comprises a UE or an NE 1400.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

FIG. 15 illustrates an example of an IoT device 1500 in accordance with aspects of the present disclosure. The IoT device 1500 may include a processor 1502, a memory 1504, an antenna 1506, and energy storage 1508. The processor 1502, the memory 1504, the antenna 1506, or the energy storage 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the antenna 1506, or the energy storage 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the IoT device 1500 to perform various functions of the present disclosure.

The memory 1504 may include volatile or non-volatile memory. The memory 1504 may store computer-readable, computer-executable code including instructions when executed by the processor 1502 cause the IoT device 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the IoT device 1500 to perform one or more of the functions described herein (e.g., executing, by the processor 1502, instructions stored in the memory 1504). For example, the processor 1502 may support wireless communication at the IoT device 1500 in accordance with examples as disclosed herein. The IoT device 1500 may be configured to or operable to support a means for receiving, from a wireless communication device, a first message that includes a set of one or more parameters associated with an energy status of the IoT device; determining the energy status based at least in part on the set of one or more parameters; and transmitting, to the wireless communication device, a second message that includes information associated with the energy status of the IoT device.

Additionally, the IoT device 1500 may be configured to support any one or combination of wherein the set of one or more parameters comprises one or more of a reference duration, a reference power consumption of the IoT device, or a type of the information associated with the energy status; and wherein the information indicates one or more of whether stored energy at the IoT device is sufficient to perform communication, a span associated with the stored energy, or a charging duration to obtain a capacitance level for performing the communication.

Additionally, or alternatively, the IoT device 1500 may be configured to support any one or combination of receiving, from the wireless communication device, a third message that schedules an occasion for communication with the IoT device based at least in part on the information; and selecting a time occasion for communicating with the wireless communication device based at least in part on the information.

Additionally, or alternatively, the IoT device 1500 may support at least one memory (e.g., the memory 1504) and at least one processor (e.g., the processor 1502) coupled with the at least one memory and configured to cause the IoT device 1500 to receive, from a wireless communication device, a first message that includes a set of one or more parameters associated with an energy status of the IoT device; determine the energy status based at least in part on the set of one or more parameters; and transmit, to the wireless communication device, a second message that includes information associated with the energy status of the IoT device.

Additionally, the IoT device 1500 may be configured to support any one or combination of wherein the set of one or more parameters comprises one or more of a reference duration, a reference power consumption of the IoT device, or a type of the information associated with the energy status; and wherein the information indicates one or more of whether stored energy at the IoT device is sufficient to perform communication, a span associated with the stored energy, or a charging duration to obtain a capacitance level for performing the communication.

Additionally, or alternatively, the IoT device 1500 may be configured to support any one or combination of receiving, from the wireless communication device, a third message that schedules an occasion for communication with the IoT device based at least in part on the information; and selecting a time occasion for communicating with the wireless communication device based at least in part on the information.

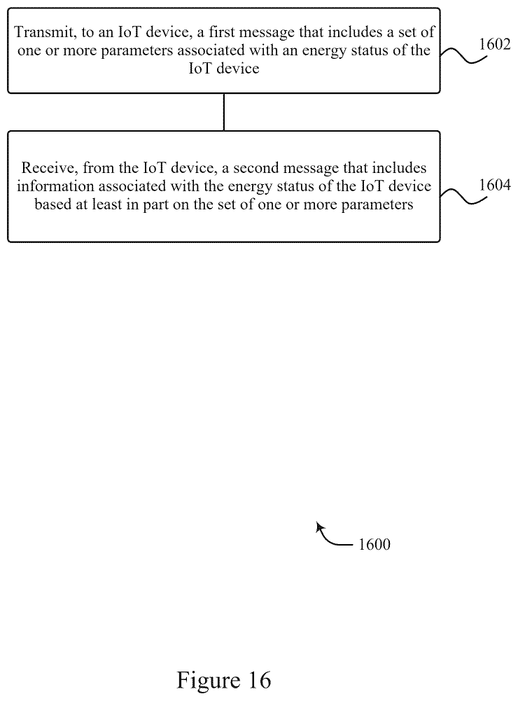

FIG. 16 illustrates a flowchart of a method 1600 in accordance with aspects of the present disclosure. The operations of the method may be implemented by a wireless communication device as described herein, such as a UE or an NE. In some implementations, the wireless communication device may execute a set of instructions to control the function elements of the wireless communication device to perform the described functions. It should be noted that the method described herein describes a possible implementation, and that the operations and the steps may be rearranged or otherwise modified and that other implementations are possible.

At 1602, the method may include transmitting, to an IoT device, a first message that includes a set of one or more parameters associated with an energy status of the IoT device. The operations of 1602 may be performed in accordance with examples as described herein. In some implementations, aspects of the operations of 1602 may be performed by a UE as described with reference to FIG. 12 or an NE as described with reference to FIG. 14.

At 1604, the method may include receiving, from the IoT device, a second message that includes information associated with the energy status of the IoT device based at least in part on the set of one or more parameters. The operations of 1604 may be performed in accordance with examples as described herein. In some implementations, aspects of the operations of 1604 may be performed by a UE as described with reference to FIG. 12 or an NE as described with reference to FIG. 14.

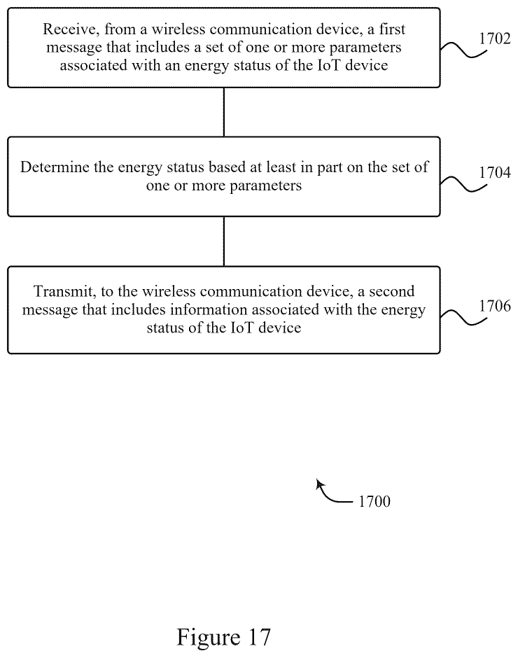

FIG. 17 illustrates a flowchart of a method 1700 in accordance with aspects of the present disclosure. The operations of the method may be implemented by an IoT device as described herein. In some implementations, the IoT device may execute a set of instructions to control the function elements of the IoT device to perform the described functions. It should be noted that the method described herein describes a possible implementation, and that the operations and the steps may be rearranged or otherwise modified and that other implementations are possible.

At 1702, the method may include receiving, from a wireless communication device, a first message that includes a set of one or more parameters associated with an energy status of the IoT device. The operations of 1702 may be performed in accordance with examples as described herein. In some implementations, aspects of the operations of 1702 may be performed by an IoT device 1500 as described with reference to FIG. 15.

At 1704, the method may include determining the energy status based at least in part on the set of one or more parameters. The operations of 1704 may be performed in accordance with examples as described herein. In some implementations, aspects of the operations of 1704 may be performed by an IoT device 1500 as described with reference to FIG. 15.

At 1706, the method may include transmitting, to the wireless communication device, a second message that includes information associated with the energy status of the IoT device. The operations of 1706 may be performed in accordance with examples as described herein. In some implementations, aspects of the operations of 1706 may be performed an IoT device 1500 as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
at least one memory; and
at least one processor coupled with the at least one memory and configured to cause the wireless communication device to:
transmit, to an Internet-of-Things (IoT) device, a first message that includes a set of one or more parameters associated with an energy status of the IoT device; and
receive, from the IoT device, a second message that includes information associated with the energy status of the IoT device based at least in part on the set of one or more parameters.

2. The wireless communication device of claim 1, wherein at least one processor is coupled with the at least one memory and configured to cause the wireless communication device to:
initiate communication with the IoT device based at least in part on the transmitted first message.

3. The wireless communication device of claim 1, wherein the set of one or more parameters comprises one or more of a reference duration, a reference power consumption of the IoT device, or a type of the information associated with the energy status.

4. The wireless communication device of claim 1, wherein the information indicates one or more of whether stored energy at the IoT device is sufficient to perform communication, a span associated with the stored energy, or a charging duration to obtain a capacitance level for performing the communication.

5. The wireless communication device of claim 1, wherein the at least one processor is further configured to cause the wireless communication device to:
transmit, to the IoT device, a third message that schedules an occasion for communication with the IoT device based at least in part on the information.

6. The wireless communication device of claim 1, wherein the at least one processor is configured to cause the wireless communication device to:
transmit, based at least in part on the energy status, a third message that triggers the IoT device to switch from a first state to a second state, wherein the first state comprises an active state, and wherein the second state comprises a deactive state.

7. The wireless communication device of claim 1, wherein the at least one processor is configured to cause the wireless communication device to:
select one or more IoT devices for communication based at least in part on the energy status being sufficient for the communication.

8. The wireless communication device of claim 1, wherein the at least one processor is configured to cause the wireless communication device to:
initiate a timer that suspends communication with the IoT device based at least in part on the information; and
transmit, to the IoT device, a third message that resumes the communication with the IoT device based at least in part on an expiration of the timer.

9. The wireless communication device of claim 1, wherein the wireless communication device comprises a user equipment (UE) or a network equipment (NE).

10. An Internet-of-Things (IoT) device, comprising:
at least one memory; and
at least one processor coupled with the at least one memory and configured to cause the IoT device to:
receive, from a wireless communication device, a first message that includes a set of one or more parameters associated with an energy status of the IoT device;
determine the energy status based at least in part on the set of one or more parameters; and
transmit, to the wireless communication device, a second message that includes information associated with the energy status of the IoT device.

11. The IoT device of claim 10, wherein the set of one or more parameters comprises one or more of a reference duration, a reference power consumption of the IoT device, or a type of the information.

12. The IoT device of claim 10, wherein the information indicates one or more of whether stored energy at the IoT device is sufficient to perform communication, a span associated with the stored energy, or a charging duration to obtain a capacitance level for performing the communication.

13. The IoT device of claim 10, wherein the at least one processor is further configured to cause the IoT device to receive, from the wireless communication device, a third message that schedules an occasion for communication with the IoT device based at least in part on the information.

14. The IoT device of claim 10, wherein the at least one processor is configured to cause the IoT device to select a time occasion for communicating with the wireless communication device based at least in part on the information.

15. A processor for wireless communication, comprising:
at least one controller coupled with at least one memory and configured to cause the processor to:
transmit, to an Internet-of-Things (IoT) device, a first message that includes a set of one or more parameters associated with an energy status of the IoT device; and
receive, from the IoT device, a second message that includes information associated with the energy status of the IoT device based at least in part on the set of one or more parameters.

16. The processor of claim 15, wherein the set of one or more parameters comprises one or more of a reference duration, a reference power consumption of the IoT device, or a type of the information associated with the energy status.

17. The processor of claim 15, wherein the information indicates one or more of whether stored energy at the IoT device is sufficient to perform communication, a span associated with the stored energy, or a charging duration to obtain a capacitance level for performing the communication.

18. The processor of claim 15, wherein the at least one controller is configured to cause the processor to select one or more IoT devices for communication based at least in part on the energy status being sufficient for the communication.

19. The processor of claim 15, wherein the at least one controller is configured to cause the processor to:
initiate a timer that suspends communication with the IoT device based at least in part on the information; and
transmit, to the IoT device, a third message that resumes the communication with the IoT device based at least in part on an expiration of the timer.

20. A method performed by a wireless communication device, the method comprising:
transmitting, to an Internet-of-Things (IoT) device, a first message that includes a set of one or more parameters associated with an energy status of the IoT device; and
receiving, from the IoT device, a second message that includes information associated with the energy status of the IoT device based at least in part on the set of one or more parameters.
